(19) United States
(12) Patent Application Publication
(10) Pub. No.: US 2025/0256966 A1
(43) Pub. Date: Aug. 14, 2025

(54) METHOD FOR REMOVING SULFUR FROM A CARBON MATERIAL

(71) Applicant: Stora Enso OYJ, Helsinki (FI)

(72) Inventors: Vilhelm Olsson, Täby (SE); Mario Wachtler, Strängnäs (SE); Stephan Walter, Bochum (DE); Katarzyna Dobrzynska, Nacka (SE)

(73) Assignee: Stora Enso OYJ, Helsinki (FI)

(21) Appl. No.: 18/858,005

(22) PCT Filed: May 9, 2023
(86) PCT No.: PCT/IB2023/054776

§ 371 Date: Oct. 18, 2024

(30) Foreign Application Priority Data
May 9, 2022 (SE) 2230138-6

(51) Int. Cl. C01B 32/05; H01M 4/587

(52) U.S. Cl. CPC C01B 32/05; H01M 4/587; C01P 2002/60; C01P 2002/78; C01P 2004/61; C01P 2006/10; C01P 2006/12; C01P 2006/40

(57) ABSTRACT

The present invention is directed to method for producing a carbon material having a sulfur content of less than 0.8 wt %, a BET specific surface area of less than 20 m²/g and an average crystallite size in the direction of the c axis (Lc) of less than 10 Å, as determined using X-ray diffraction. The method comprises the steps of providing a biobased carbon precursor, having a sulfur content in the range of from 1.0 to 5.0 wt %; subjecting the biobased carbon precursor to heat treatment in an inert atmosphere to obtain a carbon material; and subjecting the carbon material to a de-sulfurization treatment in an inert atmosphere comprising a hydrogen gas and/or at least one carbon-containing gas, so as to remove sulfur from the carbon material and obtain a carbon material having a sulfur content of less than 0.8 wt %.

### FIELD OF THE INVENTION

The present invention is directed to a method for producing a carbon material having a low sulfur content from a sulfur-containing biobased carbon precursor. The present invention is also directed to a carbon material having a low sulfur content; a negative electrode for a non-aqueous secondary battery comprising said carbon material as active material; and to use of said carbon material as active material in a negative electrode of a non-aqueous secondary battery.

### BACKGROUND

Secondary batteries, such as lithium-ion batteries, are electrical batteries which can be charged and discharged many times, i.e. they are rechargeable batteries. For example, lithium-ion batteries are today commonly used for consumer electronic devices, electric vehicles and stationary energy storage systems. Lithium-ion batteries have high energy density, high operating voltage, low self-discharge and low maintenance requirements.

In lithium-ion batteries, lithium ions flow from the negative electrode through the electrolyte to the positive electrode during discharge, and back when charging. Today, typically a lithium compound, in particular a lithium transition metal oxide, such as lithium nickel manganese cobalt oxide, or alternatively a lithium iron phosphate, is utilized as material of the positive electrode and a carbonaceous material is utilized as material of the negative electrode.

Graphite (natural or synthetic graphite) is today utilized as material of the negative electrode in most lithium-ion batteries due to their high energy density and stable charge/discharge performance over time. An alternative to graphite is amorphous carbon materials, such as hard carbons (non-graphitizable amorphous carbons) and soft carbons (graphitizable amorphous carbons), which lack long-range graphitic order. Amorphous carbons can be used as sole active electrode materials or in mixtures with graphite.

Hard carbons often have good charge/discharge rate performance which is desired for fast charging devices and high-power systems. The electrochemical charge/discharge of hard carbons occurs between ca 1.3 V vs. Li+/Li and <0 V vs. Li+/li and, when plotting the electrode potential over capacity, comprises a steadily sloping potential region above approximately 0.1 V vs. Li+/Li and an extended potential plateau region below this value. The practical capacity of hard carbons can exceed that of graphite, reaching values of 500 mAh/g and beyond. The average electrode charge/discharge potential vs. Li+/Li is higher for hard carbons than for graphite.

Both graphite and amorphous carbons work at potential ranges outside the thermodynamic stability window of the electrolyte typically used in a lithium-ion battery. During the first charge the electrolyte is decomposed, and parts of the decomposition products form a protective layer at the electrode surface, the so-called “solid electrolyte interphase” (SEI). The formation of the SEI irreversibly consumes charge, mostly during the first charge, resulting in irreversible capacity in the first (few) cycle(s) and lowering the initial Coulombic efficiency. Once the SEI is fully formed, electrolyte decomposition comes to an end and reversible cycling becomes possible.

Various biobased materials have been used to prepare amorphous carbons for use in secondary batteries. For example, U.S. Pat. No. 20,181,62733 A1 describes a carbonaceous material derived from coconut shell and U.S. Pat. No. 6,143,268 A describes a carbonaceous material derived from carbohydrates such as cellulose or sucrose.

Amorphous carbons can also be derived from lignin, such as described in for example WO9746314 A1. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. hard carbons. However, hard carbons derived from lignin have so far exhibited problems with insufficient Coulombic efficiency.

Today, the most commercially relevant source of lignin is kraft lignin. This lignin is obtained from hardwood or softwood through the kraft process. The lignin can be separated from alkaline black liquor using for example membrane-or ultrafiltration. LignoBoost is one common separation process and is described in for example WO2006031175 A1. In this process lignin is precipitated from alkaline black liquor through reducing the pH level, usually by adding carbon dioxide, and then filtered off. The lignin filter cake is in the next step re-slurried under acidic conditions, commonly using sulfuric acid, and washed. The precipitated washed lignin can be used as it is or further dried.

Kraft lignin contains high levels of sulfur due to use of sulfur-based reagents, such as sodium sulfide, during the cooking process to facilitate breaking the chemical linkages between cellulose and lignin. The sulfur will remain also in a carbon enriched material derived from kraft lignin, leading to high residual sulfur levels, typically above 1.0 wt %, in the carbon enriched material. When using the carbon enriched material in secondary batteries, the high sulfur content may cause side-reactions during battery cycling and thus reduce the long-time performance and the lifetime of the battery.

Removal of sulfur from kraft lignin by washing is challenging as a large fraction, typically more than 70%, of the sulfur in lignin is covalently bonded to carbon through carbon-sulfur linkages. Therefore, to remove sulfur from lignin, harsh chemical treatments by e.g. alkaline, oxidizing or reducing agents are required. These chemical treatments are not only expensive, but may also cause a simultaneous degradation of the lignin structure, leading to problems with quality control of the produced lignin. When converting such lignin to carbon, the resulting carbon may also exhibit structural defects, rendering such carbon unsuitable for use in batteries.

Another option is to use lignin with a low initial sulfur content, such as organosolv lignin. Such materials are however typically more expensive than kraft lignin and therefore less suitable for use as precursors for industrial production of carbon materials.

EP2831182 A2 describes removal of sulfur by an alkaline treatment of carbon black. The alkaline chemicals needed are expensive, and the pH of the carbon material is altered such that an additional neutralization step may be needed. In addition, the structure of the carbon material may be damaged.

Thus, there is a need for an improved method for producing a carbon material from a biobased carbon precursor that contains sulfur, where the obtained carbon has a low sulfur content as well as a sufficiently high initial Coulombic efficiency.

### SUMMARY OF THE INVENTION

It is an object of the present invention to provide a carbon material, obtained from a biobased carbon precursor, that has a sufficiently low sulfur content so that it can be used in energy storage applications without any negative effect on the performance of the energy storage device.

It is a further object of the present invention to provide a method for removing sulfur from a carbon material, wherein the carbon material is obtained from a biobased carbon precursor.

It is a further object of the present invention to provide a method for removing sulfur from a carbon material, which method is cost effective and compatible with large-scale manufacturing.

The above-mentioned objects, as well as other objects as will be realized by the person skilled in the art in light of the present invention, are achieved by the various aspects of the present invention.

According to a first aspect, the present invention is directed to a method for producing a carbon material having a sulfur content of less than 0.8 wt %, a BET specific surface area of less than 20 m²/g and an average crystallite size in the direction of the c axis (Lc) of less than 10 Å, as determined using X-ray diffraction, wherein the method comprises the following steps:
providing a biobased carbon precursor, wherein the biobased carbon precursor has a sulfur content in the range of from 1.0 to 5.0 wt %;
subjecting the biobased carbon precursor to heat treatment in an inert atmosphere at one or more temperatures in the range of from 500° C. to 1500° C., wherein the heat treatment is carried out for a total time of from 0.5 to 10 hours, to obtain a carbon material;
subjecting the carbon material to a de-sulfurization treatment in an inert atmosphere comprising a hydrogen gas and/or at least one carbon-containing gas, wherein the de-sulfurization treatment is carried out at one or more temperatures in the range of from 800° C. to 1300° C. for a total time period of from 10 minutes to 5 hours, so as to remove sulfur from the carbon material and obtain a carbon material having a sulfur content of less than 0.8 wt %;
wherein the de-sulfurization treatment may optionally be at least partially carried out during the heat treatment.

The inventive method according to the first aspect is based on the surprising realization that sulfur can be removed from a carbon material, obtained from a 10 sulfur-containing biobased carbon precursor, by a de-sulfurization treatment performed in an inert atmosphere comprising a hydrogen-and/or at least one carbon-containing gas. The inventive method circumvents the need to remove sulfur from the biobased carbon precursor, and therefore has the advantage of being cost-efficient as well as being scalable, enabling its use in a large-scale carbon production process. In addition, the need for de-sulfurization treatments that may potentially damage the structure of the biobased carbon precursors is reduced by the inventive method.

According to a second aspect, the present invention is directed to a carbon material for a negative electrode of a non-aqueous secondary battery, wherein the carbon material is derived from a biobased carbon precursor having a sulfur content in the range of from 1.0 to 5.0 wt %, and wherein the carbon material has a sulfur content of less than 0.8 wt %; a BET specific surface area of less than 20 m²/g; and an average crystallite size in the direction of the c axis (Lc) of less than 10 Å, as determined using X-ray diffraction. The carbon material according to the second aspect may be obtained with the method according to the first aspect.

According to a third aspect, the present invention relates to a negative electrode for a non-aqueous secondary battery comprising the carbon material obtainable by the method according to the first aspect or the carbon material according to the second aspect as active material.

According to a fourth aspect, the present invention relates to use of the carbon material obtainable by the method according to the first aspect or the carbon material according to the second aspect as active material in a negative electrode of a non-aqueous secondary battery.

The carbon material according to the present invention has a low sulfur content of less than 0.8 wt %, as well as a BET specific surface area of less than 20 m²/g and an Lc value of less than 10 Å. The low sulfur content in combination with the defined values for the BET specific surface area and Lc results in a carbon material suitable for use as the active material in a negative electrode of a non-aqueous secondary battery. A non-aqueous secondary battery comprising the carbon material according to the present invention has desirable properties, such as a sufficiently high Coulombic efficiency and good long-time cycling performance.

### DETAILED DESCRIPTION

The method according to the first aspect of the present invention involves a step of providing a biobased carbon precursor, wherein the biobased carbon precursor has a sulfur content in the range of from 1 to 5 wt %, preferably in the range of from 1 to 3 wt %, or from 1 to 2 wt %. In one embodiment, the biobased carbon precursor has a sulfur content of at least 1 wt %. The term “biobased carbon precursor”, as used herein, refers to any sulfur-containing biobased material that can be converted to a carbon material by a heat treatment. Examples of the biobased carbon precursor are tall pitch oil and sulfur-containing lignin, such as kraft lignin and lignosulfonates.

The sulfur content in the biobased carbon precursor and in the carbon material may be determined using elemental analysis, such as inductively coupled plasma (ICP) spectroscopy, organic elemental analysis (OEA) and X-ray fluorescence (XRF).

Preferably, the biobased carbon precursor is kraft lignin, i.e. lignin obtained through the kraft process. Preferably, the kraft lignin is obtained from hardwood or softwood, most preferably from softwood.

The kraft lignin may be obtained by using the process disclosed in WO2006031175 A1, commonly referred to as the LignoBoost process. Typically, this process involves the steps of precipitation of lignin from alkaline black liquor by acidification; separation of the precipitated lignin; and re-slurrying the lignin under acidic conditions at least once. The obtained lignin may be dried and pulverized and thus provided as solid particles. The lignin may be further purified before being used in the method according to the present invention. The purification is typically such that the purity of the lignin material is at least 90%, preferably at least 95%, more preferably at least 98%, based on the dry weight of the lignin material, Thus, the lignin material used according to the process of the present invention preferably contains less than 10%, preferably less than 5%, more preferably less than 2% impurities, such as cellulose and inorganic compounds, based on the dry weight of the lignin material. The sulfur content of the obtained lignin is typically in the range of from 1 to 5 wt %. The main part of the sulfur present in the lignin is covalently bonded through sulfur-carbon linkages.

In one embodiment, the kraft lignin is provided in the form of agglomerated lignin having a particle size distribution such that at least 80 wt % of the agglomerates have a diameter within the range of from 0.2 to 5.0 mm.

In the context of the present invention, the diameter of a particle is the equivalent spherical diameter of the particle, if the particle is not spherical. The equivalent spherical diameter is the diameter of a sphere of equivalent volume.

The agglomerated lignin may be obtained by the method described in WO2021250604 A1. Briefly the method comprises compacting lignin powder and crushing the compacted lignin to obtain agglomerated lignin. The agglomerated lignin may have a bulk density in the range of from 0.5 g/cm³ to 0.7 g/cm³, preferably from 0.5 g/cm³ to 0.6 g/cm³.

The compaction of the lignin is preferably carried out by roll compaction. In the compaction step, an intermediate product is generated. Here, the fine lignin powder is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased, and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction is known in the art.

In the crushing step, the intermediate product from the compaction step is subjected to crushing or grinding, such as by means of rotary granulator, cage mill, beater mill, hammer mill or crusher mill and/or combinations thereof. During this step, a further intermediate product is generated.

After crushing, the crushed material is preferably subjected to a sieving step, to remove fine material. In addition, large material, such as agglomerates having a diameter larger than 5.0 mm, may be removed and/or recirculated back to the crushing step.

Providing the kraft lignin in the form of agglomerated lignin is advantageous as the lignin is less prone to melting/swelling and changes in dimension during the subsequent heat treatment. In addition, dusting during handling of lignin powders is decreased by compacting lignin powder to agglomerates, thus avoiding problems such as explosions that can be caused by dust during the processing.

In one embodiment, the biobased carbon precursor further comprises an additive. Any suitable additives, such as binders or lubricants, may be added to facilitate the subsequent processing and to improve the density and mechanical properties of the biobased carbon precursor. In addition, additives having an influence on the properties of the final carbon material may be added, such as functionality- enhancing additives. The total amount of additive(s) is preferably less than 5 wt %, such as less than 2 wt %, as based on the total dry weight of the additive and the biobased carbon precursor.

The method according to the first aspect of the invention further comprises a step of subjecting the biobased carbon precursor to heat treatment in an inert atmosphere, at one or more temperatures in the range of from 500° C. to 1500° C., wherein the heat treatment is carried out for a total time of from 0.5 to 10 hours, to obtain a carbon material.

The term “carbon material” as used herein refers to a non-graphitizable hard carbon material obtained from a biobased carbon precursor. The carbon material consists essentially of carbon, such that it comprises at least 90 wt % carbon, or at least 95% carbon, or at least 99% carbon.

The term “heat treatment” as used herein, refers to a process of heating the biobased carbon precursor at one or more temperatures and for a sufficient time so that the carbon content of the biobased carbon precursor is increased, and so that the biobased carbon precursor is converted to a carbon material. Depending on the temperature during the heat treatment, different types of carbon materials, such as charcoal or hard carbon, can be obtained. To obtain hard carbon, a sufficiently high temperature (e.g. at least 1000° C.) must be applied at some point during the heat treatment.

The heat treatment is carried out such that the biobased carbon precursor is heated to a temperature in the range of from 500° C. to 1500° C., preferably from 600° C. to 1300° C. The heat treatment is carried out for a time period in the range of from 0.5 to 10 hours, i.e. the residence time of the biobased carbon precursor inside the equipment used for the heat treatment is in the range of from 0.5 to 10 hours.

The heat treatment may be carried out at the same temperature throughout the entire heat treatment or may be carried out at varying temperature, such as a stepwise increase of the temperature or using a temperature gradient. The heat treatment may comprise a temperature ramp from a starting temperature to a target temperature. The heating rate may be 1-100° C./min. For example, the heat treatment may involve several intermediate temperatures, with temperature ramps in between them, before reaching the target temperature needed for carbonization of the biobased carbon precursor. The heat treatment may be carried out as a batch process or a continuous process. Any suitable reactor can be used. The heat treatment is carried out under inert atmosphere, preferably nitrogen atmosphere.

Preferably, the heat treatment comprises a first heating step, preferably followed by a final heating step. The first heating step is preferably carried out at one or more temperatures in the range of from 500° C. to 900° C., such as between 500° C. and 700° C., for a time period of from 0.5 to 5 hours. The BET specific surface area of the product obtained after the first heating step is typically in the range of from 100 to 700 m²/g. The BET specific surface area is measured using nitrogen gas.

The final heating step is preferably carried out at one or more temperatures in the range of from 900° C. to 1500° C., such as between 1000° C. and 1300° C., for a time period of from 10 minutes to 3 hours. After a final heating step carried out at 1000° C. or higher, the BET specific surface area of the product obtained is typically less than 50 m²/g, preferably less than 20 m²/g. The BET specific surface area is measured using nitrogen gas.

The first and final heating steps may be carried out as discrete steps or as one single step in direct sequence. The first and final heating steps may involve heating at one or more temperatures, as discussed above for the heat treatment. For example, the first heating involves increasing the temperature to about 700° C. The final heating step is preferably carried out between 1000° C. and 1300° C., such as at about 1000° C.

The heat treatment can be carried out continuously or in batch mode. The heating can be carried out using methods known in the art and is carried out in an inert atmosphere, such as in a nitrogen atmosphere. Preferably, the heating is carried out in a rotary kiln, moving bed furnace, pusher furnace or rotary hearth furnace. If a first heating step and a final heating step is carried out, these may be carried out in the same furnace or in different furnaces.

After the heat treatment, the obtained carbon material has a BET specific surface area of less than 20 m²/g, preferably less than 15 m²/g and even more preferably less than 10 m²/g. The surface area is measured using the BET method with nitrogen gas. For a carbon material that is to be used in an energy storage device, such as in a non-aqueous secondary battery, it is important that the surface area is not higher than about 20 m²/g, as the performance of the battery may otherwise be impaired. For example, decomposition reactions with the electrolyte may occur, as well as a decrease in charge/discharge capacity retention. One way of obtaining a low surface area is to carry out at least one stage of the heat treatment at a temperature of at least 1000° C.

The obtained carbon material after the heat treatment has an average crystallite size in the direction of the c axis (Lc) of less than 10 Å, preferably less than 9.5 Å, as determined using X-ray diffraction. The Lc value corresponds to the average total thickness of stacked carbon layers in a graphite-like area of the carbon. It is important that the obtained carbon material has an Lc-value of less than 10 Å, so that a non-aqueous secondary battery utilizing the carbon material in the negative electrode will have good output characteristics, such as charge/discharge performance and low resistance. In one embodiment, the obtained carbon material has an Lc-value in the range of from 8 Å to 10 Å, or from 8 Å to 9.5 Å. A carbon material having an Lc value within the defined range can be obtained by selecting an appropriate temperature during heat treatment, as known by a person skilled in the art.

The obtained carbon material may have a helium true density in the range of from 1.4 to 2.1 g/cm³. The helium true density may be determined using a pycnometer, as known by a person skilled in the art. It is important to have a helium true density in the range of from 1.4 to 2.1 g/cm³ as the doping and de-doping capacity of the carbon material when used as the active material in the negative electrode of a non-aqueous secondary battery may otherwise be reduced, and the irreversible capacity of the battery may become large. If the density of the carbon material is too low, the energy density of the electrode may also be decreased.

The obtained carbon material may have a hydrogen atom to carbon atom (H/C) ratio of less than 0.01, preferably less than 0.005, as determined by elemental analysis. If the H/C ratio is higher than 0.01, the irreversible capacity of a non-aqueous secondary battery in which the carbon material is used, can become large. A low H/C ratio is desired also in order to enable a low electrical resistance, due to increased aromaticity of the carbon structure. The temperature used during heat treatment can be used to control the H/C ratio.

The obtained carbon material may have an oxygen atom to carbon atom (O/C) ratio of less than 0.04, preferably less than 0.035, as determined by elemental analysis. If the O/C ratio is higher than 0.04, the irreversible capacity of a non-aqueous secondary battery in which the carbon material is used, can become large. A low O/C ratio is desired also in order to enable a low electrical resistance and a good initial Coulombic efficiency.

In general, low ratios of both H/C and O/C are desired, as this indicates that a large portion of the biobased carbon precursor has been converted to carbon. Remaining hydrogen and oxygen can contribute to unwanted reactions when the obtained carbon material is used as active material in the negative electrode of a non-aqueous secondary battery, thus reducing the performance of the battery. The presence of heteroatoms like hydrogen and oxygen may also interfere with the graphitic planes in graphitic-like areas of the carbon material and thus cause defects which will have an impact on the electrochemical properties of the carbon material.

Different methods of elemental analysis, such as organic elemental analysis (OEA), may be used to determine the H/C ratio and the O/C ratio.

The obtained carbon material may have an average lattice spacing (d₀₀₂) in the range of from 3.5 Å to 4.0 Å, preferably in the range of from 3.6 Å to 3.9 Å, as determined by X-ray diffraction. The d₀₀₂ value corresponds to the distance between carbon layers in a graphite-like area of the carbon material. By having a d₀₀₂ value in the defined range, the carbon material can be used to construct a battery with good performance, in particular with regards to capacity. A sufficiently large d₀₀₂ value is required for intercalation of ions, like lithium, and also larger ions, like sodium.

The method according to the first aspect further comprises a step of subjecting the obtained carbon material to a de-sulfurization treatment in an inert atmosphere comprising a hydrogen gas and/or at least one carbon-containing gas, wherein the de-sulfurization treatment is carried out at one or more temperatures in the range of from 800° C. to 1200° C., preferably from 900° C. to 1100° C., for a total time period of from 10 minutes to 5 hours, preferably from 30 minutes to 3 hours, so as to remove sulfur from the carbon material and obtain a carbon material having a sulfur content of less than 0.8 wt %.

The term “de-sulfurization treatment”, as used herein, refers to a gas treatment that removes sulfur from a carbon material, thus reducing the total amount of sulfur present in the carbon material.

The term “inert atmosphere” as used herein, refers to an atmosphere that is depleted of oxygen. Preferably, the content of oxygen in the inert atmosphere is less than 1 vol %, such as less than 0.1 vol %. In one embodiment, the inert atmosphere during the de-sulfurization treatment is composed of nitrogen as well as hydrogen gas and/or at least one carbon-containing gas.

The de-sulfurization treatment may be carried out at the same temperature throughout the entire de-sulfurization treatment or may be carried out at varying temperature, such as a stepwise increase of the temperature or using a temperature gradient. The de-sulfurization treatment may comprise a temperature ramp from a starting temperature to a target temperature. The heating rate may be 1-100° C./min. For example, the de-sulfurization treatment may involve several intermediate temperatures, with temperature ramps in between them, before reaching the target temperature needed for removal of sulfur.

The de-sulfurization treatment is carried out for a total time period of from 10 minutes to 5 hours. The total time period in this case refers to the total time that the carbon material is in contact with hydrogen gas and/or at least one carbon- containing gas inside the reactor, or the total time during which hydrogen gas and/or at least one carbon-containing gas is supplied to the reactor.

The de-sulfurization treatment may be performed using both hydrogen gas and at least one carbon-containing gas, or only using hydrogen gas, or only using at least one carbon-containing gas. In one embodiment, the de-sulfurization is performed using hydrogen gas and at least one carbon-containing gas at least partially at the same time. In one embodiment, the de-sulfurization treatment is performed using hydrogen gas, with subsequent addition of at least one carbon-containing gas. In one embodiment, the de-sulfurization treatment is performed using first hydrogen gas and then at least one carbon-containing gas in separate steps.

In one embodiment, the total amount of hydrogen gas and/or the at least one carbon-containing gas during the de-sulfurization treatment is in the range of from 5 to 30 vol %. The term “total amount” as used herein refers to the sum of the amount of hydrogen gas and the amount of the at least one carbon-containing gas present inside the reactor used for the de-sulfurization treatment. In one embodiment, the de-sulfurization treatment is carried out in an inert atmosphere comprising in the range of from 70 to 95 vol % nitrogen and in the range of from 5 to 30 vol % hydrogen gas and/or at least one carbon-containing gas. In one embodiment, the de-sulfurization treatment is carried out in an inert atmosphere comprising in the range of from 70 to 95 vol % nitrogen and in the range of from 5 to 30 vol % hydrogen gas.

In one embodiment, the de-sulfurization treatment is carried out in an inert atmosphere comprising in the range of from 80 to 95 vol % nitrogen and in the range of from 5 to 20 vol % of at least one carbon-containing gas. In one embodiment, the concentration of hydrogen gas and/or the at least one carbon-containing gas remains the same during the entire de-sulfurization treatment. In one embodiment, the concentration of hydrogen gas and/or the at least one carbon-containing gas varies during the de-sulfurization treatment, such that the concentration increases or decreases during the de-sulfurization treatment. The hydrogen gas or the at least one carbon-containing gas may be supplied together with the inert gas to the reactor, or as a separate flow. Preferably, the hydrogen gas or the at least one carbon-containing gas is supplied as a separate flow for improving the control of the supply. The hydrogen gas or the at least one carbon-containing gas are preferably mixed with an inert gas, such as nitrogen, also when supplied as a separate flow.

In an alternative embodiment, the total amount of hydrogen gas and/or the at least one carbon-containing gas during the de-sulfurization treatment is in the range of from 5 to 60 vol %, such as in the range of from 20 to 45 vol %, or from 30 to 40 vol %. For example, the de-sulfurization treatment may be carried out in an inert atmosphere comprising in the range of from 60 to 70 vol % nitrogen and in the range of from 30 to 40 vol % hydrogen gas.

The term “carbon-containing gas” as used herein refers to any carbon-containing compound that is in gas form, or that can be volatilized to a gas. In one embodiment, the at least one carbon containing gas has the general structure CₓH_{y} and preferably the number of carbon atoms is in the range of from 1 to 4, and the number of hydrogen atoms is in the range of from 2 to 8. In one embodiment, the at least one carbon-containing gas is selected from at least one of methane, ethane, propane, methylene, ethylene, propylene, acetylene and methylacetylene. In a preferred embodiment, the at least one carbon-containing gas is selected from acetylene and ethylene. As realized by a person skilled in the art, the temperature during the de-sulfurization step may have to be adjusted depending on the type of carbon-containing gas used.

In some embodiments, only one carbon-containing gas is used for the de-sulfurization treatment. In a preferred embodiment, the carbon-containing gas is selected from acetylene or ethylene.

In some embodiments, more than one carbon-containing gas is used for the de-sulfurization treatment. In a preferred embodiment using two carbon-containing gases, the carbon-containing gases are acetylene and ethylene.

In some embodiment, hydrogen gas and one carbon-containing gas is used for the de-sulfurization treatment. In a preferred embodiment using both hydrogen gas and a carbon-containing gas, the carbon-containing gas is selected from methane or ethane.

In embodiments where at least one carbon-containing gas is used for the de-sulfurization treatment, the de-sulfurization treatment may also result in the carbon material being coated with a carbon coating. Depending on parameters such as the concentration of the at least one carbon-containing gas and the temperature, a coating is obtained or not. Typically, a high concentration of the at least one carbon-containing gas and a high temperature is required for deposition of a carbon coating on the carbon material. If a carbon-coated carbon material is desired, the de-sulfurization treatment using a carbon-containing gas can, at least partially, be carried out during a coating step, such as during a chemical vapour deposition (CVD) treatment.

In one embodiment, the de-sulfurization treatment is at least partially carried out during the heat treatment. In one embodiment, the entire de-sulfurization treatment is carried out during the heat treatment. In one embodiment, the de-sulfurization treatment is carried out at least partially during the final heating step. By carrying out at least parts of the de-sulfurization treatment during the heat treatment, a more efficient process is achieved, as fewer heating steps are required.

If the de-sulfurization treatment is entirely carried out during the heat treatment, the total time of the heat treatment may be longer than the total time of the de-sulfurization. Preferably, the de-sulfurization treatment starts (by supplying hydrogen gas or at least one carbon-containing gas), when the temperature has reached at least 800° C. The heat treatment may also continue after the de-sulfurization treatment has stopped.

In one embodiment, the entire de-sulfurization treatment is performed after the heat treatment. The de-sulfurization treatment may in this embodiment begin with heating the carbon in an inert atmosphere to a temperature of at least 800° C. for a time period of from 0.5 to 2 hours before hydrogen gas and/or at least one carbon-containing gas is applied. The heating ensures that the carbon material has a sufficient temperature at the beginning of the treatment with hydrogen gas and/or at least one carbon-containing gas. The carbon material may also be cooled down in an inert atmosphere after the de-sulfurization treatment.

In one embodiment, the de-sulfurization treatment comprises a first de-sulfurization step and a second de-sulfurization step. One or both of the first or second de-sulfurization steps may be performed at least partially during the heat treatment. Parameters such as temperature, time and the concentration and composition of the gases used during the de-sulfurization treatment may be the same or vary between the different de-sulfurization steps. By optimizing such parameters, a more efficient removal of sulfur from the carbon material may be achieved. By performing the de-sulfurization treatment in two steps, a more efficient removal of sulfur can be achieved.

The first and second de-sulfurization steps may be carried out as discrete steps or as one single step in direct sequence. The temperature(s) during the first and final heating steps may be the same or may vary, as described above for the de-sulfurization treatment.

In one embodiment, the first de-sulfurization step is carried out during the heat treatment. In one embodiment, the first de-sulfurization step is carried out in an inert atmosphere comprising hydrogen gas. The amount of hydrogen gas in the first de-sulfurization step may be in the range of from 5 to 30 vol %. The first de-sulfurization step may be carried out at a temperature in the range of from 800° C. to 1300° C. for a total time period in the range of from 10 minutes to 3 hours. In one embodiment, the first de-sulfurization step is carried out during the final heating step. By carrying out the first de-sulfurization step during the final heating step, a more efficient process is achieved as the number of process steps are reduced. As discussed above for the de-sulfurization treatment, the total time of the final heating step may be longer than the total time of the first de-sulfurization step.

In one embodiment, the second de-sulfurization step is carried out in a separate step after the heat treatment. The second de-sulfurization step may in this embodiment begin with heating the carbon in an inert atmosphere to a temperature of at least 800° C. for a time period of from 0.5 to 2 hours before hydrogen gas and/or at least one carbon-containing gas is applied. The heating ensures that the carbon material has a sufficient temperature at the beginning of the treatment with hydrogen gas and/or at least one carbon-containing gas. The carbon material may also be cooled down in an inert atmosphere after the second de-sulfurization step.

In one embodiment, the second de-sulfurization step is carried out in an inert atmosphere comprising the at least one carbon-containing gas. The amount of the at least one carbon-containing gas may be in the range of from 5 to 20 vol %. The second de-sulfurization step may be carried out at a temperature in the range of from 800° C. to 1100° C. for a total time period of from 10 minutes to 3 hours. The second de-sulfurization may be carried out during CVD coating of the carbon material. By performing two de-sulfurization steps, a more efficient removal of sulfur may be achieved.

In one embodiment, the de-sulfurization treatment comprises a first de-sulfurization step carried out in an inert atmosphere comprising hydrogen gas and carried out during the final heating step; and a second de-sulfurization step carried out in an inert atmosphere comprising at least one carbon-containing gas and carried out after the heat treatment, preferably during CVD coating. By carrying out the first de-sulfurization step in an atmosphere comprising hydrogen gas, the temperature and time can be optimized such that the sulfur removal is more efficient. Due to the different properties of hydrogen gas and the at least one carbon-containing gas, different temperatures and times are suitable for an optimized sulfur removal in the different atmospheres. It is therefore in some embodiments advantageous to carry out the de-sulfurization treatment in two steps, using hydrogen gas in a first step and at least one carbon-containing gas in a second step. In addition, by only supplying a carbon-containing gas in the second step, excess soot formation is prevented.

The de-sulfurization treatment can be carried out continuously or in batch mode. Any suitable reactor can be used. Preferably, the de-sulfurization treatment is carried out in a rotary kiln, moving bed furnace, fluidised bed, pusher furnace, or rotary hearth furnace. If a first de-sulfurization step and a second de-sulfurization step is carried out, these may be carried out in the same furnace or in different furnaces.

Sulfur is removed from the carbon material by the de-sulfurization treatment. It is believed that the de-sulfurization treatment results in the formation of hydrogen sulfide or carbon disulfide or other volatile sulfur compounds. Due to their volatility, these compounds will not remain in the carbon. After the de-sulfurization treatment, the obtained carbon has a sulfur content of less than 0.8 wt %, such as less than 0.7 wt %, or less than 0.5 wt % or less than 0.3 wt %. In one embodiment, the obtained carbon has a sulfur content in the range of from 0 to 0.8 wt %, such as from 0 to 0.7 wt %, or from 0 to 0.5 wt %, or from 0 to 0.3 wt %. In one embodiment, the obtained carbon has a sulfur content in the range of from 0.01 to 0.8 wt %, such as from 0.01 to 0.7 wt %, or from 0.01 to 0.5 wt %, or from 0.01 to 0.3 wt %. In one embodiment, the obtained carbon has a sulfur content in the range of from 0.1 to 0.8 wt %, such as from 0.1 to 0.7 wt %, or from 0.1 to 0.5 wt %, or from 0.1 to 0.3 wt %.

In one embodiment, where the de-sulfurization treatment is carried out in an inert atmosphere comprising at least one carbon-containing gas, the obtained carbon material after the de-sulfurization treatment has a BET specific surface area (measured with nitrogen gas) of less than 5 m²/g and a helium true density in the range of from 1.4 to 1.8 g/cm³. In one embodiment, a carbon-containing gas is not used during the de-sulfurization treatment, and the carbon material instead has a BET specific surface area (measured with nitrogen gas) of less than 20 m²/g and a helium true density in the range of from 1.4 to 2.1 g/cm³. The de-sulfurization treatment typically does not have any significant impact on the Lc-value, the d₀₀₂—value, or the H/C ratio, regardless of which gas is used during the de-sulfurization treatment. After the de-sulfurization treatment, these parameters thus remain within the same ranges as defined for the carbon material obtained after the heat treatment. The O/C ratio is typically somewhat lowered by the de-sulfurization treatment, in particular when at least one carbon-containing gas is used for the de-sulfurization treatment.

In one embodiment, the method according to the first aspect of the invention comprises an additional step of pre-heating the bio-based carbon precursor to a temperature in the range of from 180° C. to 250° C. for a time period of at least 0.5 hours in an oxidizing atmosphere, wherein the pre-heating is performed prior to the heat treatment.

The pre-heating is carried out such that the biobased carbon precursor is heated to a temperature in the range of from 180° C. to 250° C., preferably from 180° C. to 230° C. The pre-heating is carried out for at least 30 minutes, i.e. the residence time of the biobased carbon precursor inside the equipment used for the pre-heating is at least 30 minutes. In one embodiment, the pre-heating is carried out for at least 1 hour, or at least 1.5 hours. Preferably, the pre-heating is carried for less than 12 hours, or less than 6 hours. The pre-heating may be carried out at the same temperature throughout the entire pre-heating stage or may be carried out at varying temperature, such as a stepwise increase of the temperature or using a temperature gradient. More preferably, the pre-heating is carried out such that biobased carbon precursor is first heated to a temperature in the range of from 140° C. to 175° C. for a period of at least 15 minutes and subsequently heated to a temperature in the range of from 175° C. to 250° C. for at least 15 minutes.

The step of pre-heating the biobased carbon precursor can be carried out continuously or in batch mode. The pre-heating can be carried out using methods known in the art and is carried out in an oxidizing atmosphere, such as air. Oxygen is required due to the low temperature used during the pre-heating. Preferably, the pre-heating is carried out in a rotary kiln, moving bed furnace or rotary hearth furnace.

In embodiments where the biobased carbon precursor is lignin, the thermal stability of the lignin is improved by performing a pre-heating step, such that a thermally stabilized lignin is obtained. In particular, the processability of the lignin in terms of avoiding melting/swelling and retaining shape and dimension during the subsequent heat treatment is improved by the pre-heating step.

In one embodiment the method further comprises a step of pulverizing the carbon material so as to obtain pulverized carbon material having an average particle size (D_{V50}) in the range of from 5 μm to 25 μm, preferably in the range of from 7 to 15 μm. When using the carbon material as active material in a negative electrode of a non-aqueous secondary battery, it is important that the average particle size is not too large as charging and discharging may otherwise be too slow. If on the other hand the average particle size is too small, the surface area will increase. This will have a negative impact on battery properties such as capacity and reactivity with the electrolyte. The average particle size (D_{V50}) may be determined using for example laser diffraction.

Pulverization may be carried out by any method as known in the art. Some examples include a cutting mill, blade mixer, ball-mill, impact mill, hammer mill and/or jet-mill. Optionally, fine/coarse particle selection by classification and/or sieving may be performed subsequent to the pulverization.

In embodiments where the heat treatment comprises a first heating step and a final heating step, the step of pulverization may be performed after the first heating step or after the final heating step. The pulverization may be performed either prior to the de-sulfurization treatment or after the de-sulfurization treatment.

After heat treatment and de-sulfurization, the obtained carbon material may undergo further processing, such as e.g. carbon-coating by chemical vapor deposition (CVD), pitch coating, thermal and/or chemical purification (other than de-sulfurization), further heat treatment(s), particle size adjustment, and blending with other electrode materials to e.g. further improve its electrochemical performance.

The carbon material obtained by the method according to the first aspect is preferably used as an active material in a negative electrode of a non-aqueous secondary battery, such as a lithium-ion battery. Due to the low sulfur content in the carbon material used as active material in the negative electrode, the long-time performance as well as the lifetime of the non-aqueous secondary battery is improved. In addition, the Coulombic efficiency is sufficiently high.

When the carbon material obtained by the method according to the first aspect is used for producing a negative electrode, any suitable method to form such a negative electrode may be utilized. In the formation of the negative electrode, the carbon enriched material may be processed together with further components. Such further components may include, for example, one or more binders to form the carbon material into an electrode, conductive materials, such as carbon black, carbon nanotubes or metal powders, and/or further Li storage materials, such as graphite or lithium. For example, the binders may be selected from, but are not limited to, poly (vinylidene fluoride), poly (tetrafluoroethylene), carboxymethylcellulose, natural butadiene rubber, synthetic butadiene rubber, polyacrylate, poly (acrylic acid), alginate, etc., or from combinations thereof. Optionally, a solvent such as e.g. 1-methyl-2-pyrrolidone, 1-ethyl-2-pyrrolidone, water, or acetone is utilized during the processing.

According to a second aspect, the present invention relates to a carbon material for a negative electrode of a non-aqueous secondary battery, wherein the carbon material is derived from a biobased carbon precursor having a sulfur content in the range of from 1.0 to 5.0 wt %, and wherein the carbon material has a sulfur content of less than 0.8 wt %; a BET specific surface area of less than 20 m²/g; and an average crystallite size in the direction of the c axis (Lc) of less than 10 Å, as determined using X-ray diffraction. The carbon material according to the second aspect may be obtained by the method according to the first aspect. The carbon material according to the second aspect is suitable for use as active material in a negative electrode of a non-aqueous secondary battery as it has a low sulfur content. The carbon material according to the second aspect may be further defined as set out above with reference to the first aspect.

According to a third aspect, the present invention relates to a negative electrode for a non-aqueous secondary battery comprising the carbon material obtainable by the method according to the first aspect or the carbon material according to the second aspect as active material. The negative electrode according to the third aspect may be further defined as set out above with reference to the first aspect.

According to a fourth aspect, the present invention relates to use of the carbon material obtainable by the method according to the first aspect or the carbon material according to the second aspect as active material in a negative electrode of a non-aqueous secondary battery. The negative electrode according to the fourth aspect may be further defined as set out above with reference to the first aspect.

### EXAMPLES

### Example 1

Kraft lignin powder obtained from the LignoBoost process and having sulfur content of 2 wt % was heat treated to obtain a carbon material. The heat treatment was carried out in nitrogen atmosphere by heating first at 500° C. and then by increasing up to a final temperature of 1000° C. The obtained carbon material was allowed to cool down to room temperature before being pulverized to an average particle size of 15 μm using a jet-mill. De-sulfurization treatment was carried out in a rotary kiln by initial heating at 1050° C. for 1 hour in a nitrogen atmosphere, followed by lowering the temperature to 900° C. and changing the atmosphere to 25 vol % acetylene (and 75 vol % nitrogen). Heating was maintained for 2 hours whereafter the gas atmosphere was shifted to nitrogen and the carbon material was cooled down to room temperature.

### Example 2

Kraft lignin powder obtained from the LignoBoost process and having sulfur content of 2 wt % was heat treated to obtain a carbon material. The heat treatment was performed first at 500° C. and then by increasing up to a final temperature of 1000° C. in nitrogen atmosphere. The obtained carbon material was allowed to cool down to room temperature before being pulverized to an average particle size of 10 μm using a jet-mill. De-sulfurization treatment was carried out in a fluidized bed reactor at 900° C. for 2 hours in a nitrogen atmosphere comprising 5% hydrogen gas. After the de-sulfurization, the carbon material was cooled down to room temperature under nitrogen atmosphere.

### Example 3

Kraft lignin powder obtained from the LignoBoost process and having sulfur content of 2 wt % was heat treated to obtain a carbon material. The heat treatment was performed first at 500° C. The obtained carbon material was allowed to cool down to room temperature before being pulverized to an average particle size of 10 μm using a jet-mill. De-sulfurization treatment was carried out in a rotary kiln reactor at 1050° C. for 2 hours in a nitrogen atmosphere comprising 40% hydrogen gas. After the de-sulfurization, the carbon material was cooled down to room temperature under nitrogen atmosphere.

### Example 4—Comparative

A carbon material was produced as outlined for example 1 above, except that the de-sulfurization treatment was omitted.

The carbon materials obtained in examples 1-4 were analyzed and the results are presented in table 1. The BET specific surface area was determined using nitrogen.

The true density was measured with helium using a pycnometer. The sulfur content, H/C ratio and O/C ratio were determined using organic elemental analysis using flash combustion. The Lc value and d₀₀₂ value were determined using wide angle X-ray diffraction.

### Example 5

In this example, electrodes were prepared from the carbon material powder obtained in examples 1, 2 and 4. The electrodes were prepared as follows: 82 wt % carbon powder was mixed with 8 wt % poly (vinylidene fluoride) binder dissolved in 1-methyl-2-pyrrolidone, this mixture was coated onto Cu foil via a doctor-blade process and dried. Lab-type 3-electrode cells were built from the carbon electrodes, each cell comprising a carbon electrode, a Li metal counter electrode and a Li metal reference electrode, using glass fibre separators and 1M LiPF₆ dissolved in ethylene carbonate: dimethyl carbonate (1:1 by weight) as electrolyte. The cells were galvanostatically charged and discharged between 0 mV vs. Li/Li+and 1.5 V vs. Li/Li+ using a specific current of 74.4 mA/g (AM), where g(AM) denotes the mass of active material in the electrode. The charge and discharge capacities as well as the initial Coulombic efficiency were evaluated. Results for the carbon materials obtained from examples 1, 2 and 4 are outlined in table 1.

TABLE 1

| | | surface | He true | Sulfur | | | | | charge | discharge | Coulombic |
|---|---|---|---|---|---|---|---|---|---|---|---|
| | D_{V50} | area | density | content | | | D₀₀₂ | Lc | capacity | capacity | efficiency |
| Ex. | (μm) | (m²/g) | (g/cm³) | (wt %) | H/C | O/C | (Å) | (Å) | (mAh/g) | (mAh/g) | (%) |
| 1 | 15 | 1.1 | 1.47 | 0.17 | 0.0028 | 0.012 | 3.7 | 9.0 | 354 | 289 | 82 |
| 2 | 10 | ND | ND | 0.59 | 0.004 | ND | ND | ND | 636 | 430 | 67 |
| 3 | 10 | ND | ND | 0.04 | ND | ND | ND | ND | ND | ND | ND |
| 4 | 12 | ND | 2.02 | 0.97 | 0.004 | 0.033 | 3.7 | 9.1 | 635 | 401 | 63 |

In view of the above detailed description of the present invention, other modifications and variations will become apparent to those skilled in the art. However, it should be apparent that such other modifications and variations may be effected without departing from the spirit and scope of the invention.

1. A method for producing a carbon material having a sulfur content of less than 0.8 wt %, a BET specific surface area of less than 20 m²/g and an average crystallite size in a direction of a c axis (Lc) of less than 10 Å, as determined using X-ray diffraction, wherein the method comprises the following steps:
providing a biobased carbon precursor, wherein the biobased carbon precursor has a sulfur content in a range of from 1.0 to 5.0 wt %;
subjecting the biobased carbon precursor to a heat treatment in an inert atmosphere at one or more temperatures in a range of from 500° C. to 1500° C., wherein the heat treatment is carried out for a total time of from 0.5 to 10 hours, to obtain a carbon material;
subjecting the carbon material to a de-sulfurization treatment in an inert atmosphere comprising a hydrogen gas, or at least one carbon-containing gas, or both, wherein the de-sulfurization treatment is carried out at one or more temperatures in a range of from 800° C. to 1300° C. for a total time period of from 10 minutes to 5 hours, so as to remove sulfur from the carbon material and obtain a carbon material having a sulfur content of less than 0.8 wt %;
wherein the de-sulfurization treatment is, optionally, at least partially carried out during the heat treatment.

2. The method according to claim 1, wherein the biobased carbon precursor is kraft lignin.

3. The method according to claim 2, wherein the kraft lignin comprises agglomerated lignin having a particle size distribution such that at least 80 wt % of agglomerated lignin particles have a diameter within the a range of from 0.2 to 5.0 mm.

4. The method according to claim 1, wherein the method further comprises a step of:
pre-heating the bio-based carbon precursor to a temperature in a range of from 180° C. to 250° C. for a time period of at least 30 minutes in an oxidizing atmosphere, and wherein the pre-heating step is performed prior to the heat treatment.

5. The method according to claim 1, wherein the method further comprises a step of:
pulverizing the carbon material to obtain a pulverized carbon material having an average particle size (D_{V50}) in the a range of from 5 μm to 25 μm.

6. The method according to claim 1, wherein the de-sulfurization treatment comprises a first de-sulfurization step and a second de-sulfurization step.

7. The method according to claim 6, wherein the first de-sulfurization step is carried out during the heat treatment.

8. The method according to claim 6, wherein the first de-sulfurization treatment is carried out in an inert atmosphere comprising hydrogen gas.

9. The method according to claim 8, wherein the first de-sulfurization step is carried out at one or more temperatures in a range of from 800° C. to 1300° C. for a time period in the a range of from 10 minutes to 3 hours.

10. The method according to claim 6, wherein the second de-sulfurization step is carried out in a separate step after the heat treatment.

11. The method according to claim 6, wherein the second de-sulfurization step is carried out in an inert atmosphere comprising the at least one carbon-containing gas.

12. The method according to claim 11, wherein the second de-sulfurization step is carried out at one or more temperatures in a range of 800° C. to 1100° C. for a time period in the a range of from 10 minutes to 3 hours.

13. The method according to claim 1, wherein the heat treatment comprises a first heating step, followed by a final heating step.

14. The method according to claim 13, wherein the first heating step is carried out at one or more temperatures in a range of from 500° C. to 900° C. for a time period in the a range of from 0.5 to 5 hours.

15. The method according to claim 13, wherein the final heating step is carried out at one or more temperatures in a range of from 900° C. to 1500° C. for a time period in the a range of from 10 minutes to 3 hours.

16. The method according to claim 13, wherein the step of pulverization may be performed after the first heating step or after the final heating step.

17. The method according to claim 13, wherein the de-sulfurization treatment is carried out at least partially during the final heating step.

18. The method according to claim 17, wherein the first de-sulfurization step is carried out during the final heating step.

19. A carbon material for a negative electrode of a non-aqueous secondary battery, wherein the carbon material is derived from a biobased carbon precursor having a sulfur content in a range of from 1.0 to 5.0 wt %, and wherein the carbon material has a sulfur content of less than 0.8 wt %; a BET specific surface area of less than 20 m²/g; and an average crystallite size in a direction of a c axis (Lc) of less than 10 Å, as determined using X-ray diffraction.

20. The carbon material according to claim 19, wherein the carbon material has an average particle size (D_{V50}) in the a range of from 5 μm to 25 μm.

21. The carbon material according to claim 19, wherein the carbon material has a helium true density in a range of from 1.4 to 2.1 g/cm³.

22. The carbon material according to claim 19, wherein the carbon material has a hydrogen atom to carbon atom (H/C) ratio of less than 0.01, as determined by elemental analysis.

23. The carbon material according to claim 19, wherein the carbon material has an oxygen atom to carbon atom (O/C) ratio of less than 0.04, as determined by elemental analysis.

24. The carbon material according to claim 19, wherein the carbon material has an average lattice spacing (d₀₀₂) in the a range of from 3.5 Å to 4.0 Å, as determined by X-ray diffraction.

25. The carbon material according to claim 19, wherein the biobased carbon precursor is kraft lignin.

26. (canceled)

27. (canceled)
